(19) United States
(12) Patent Application Publication
(10) Pub. No.: US 2011/0094090 A1
(43) Pub. Date: Apr. 28, 2011

(54) HOT-FORMING MAGNETIC COMPONENT

(76) Inventor: S. R. SHANG, Ta Wu Lung Keelung (TW)

(21) Appl. No.: 12/603,625

(22) Filed: Oct. 22, 2009

(51) Int. Cl. H01F 7/06

(52) U.S. Cl. 29/602.1

(57) ABSTRACT

The invention relates to a hot-forming magnetic component composed of core, assembled coil, and magnetic glue. It can make no air gap between the core of magnetic component and magnetic shielding material, avoid gap loss, reduce equipments or molds wear, and enhance the magnetic paths and permeability.

### BACKGROUND OF THE INVENTION

1. Technical Field The present invention relates to a hot-forming magnetic component which is applicable to large current inductors, electronic components, electromagnetic control components, or the like of magnetic components.

2. Description of Related Art

To solve the winding problems of conventional magnetic components, columnar cores are gradually being adopted in the related industry. FIG. 11 is a sectional view of a conventional open magnetic component, showing that it can generate loops of magnetic field lines surrounding the current-carrying coils 1. Most of the lines diverge radially from the center of core 2 and become the major source of EMI. However, its paths are in the air so that it doesn't have the function of enhancing the magnetic field induction.

With a view to improving the aforesaid defect, a casing 3 is typically provided outside the core 2, which is called drum core. FIG. 12 is a cross sectional view of a conventional drum core, which has the following two major advantages comparing to the open magnetic component:

1. With the paths of applied field lines being extended in the magnetic material, the general output intensity of magnetic field is enhanced.

2. With the casing 3 conducting the field lines into the material of the casing 3, the diverging field lines are reduced.

However, the drum core design described above is disadvantaged by gaps 31 as shown by the hatched areas in FIG. 10 between components of the drum core. Since the drum core is an assembly of multiple components, the gaps 31 are unavoidable. More importantly, these gaps 31 contribute to more than 50% of core loss, and also cause the EMI that is happened from coil and core vibration.

### BRIEF SUMMARY OF THE INVENTION

According to the defect of aforesaid columnar core and drum core, a hot-forming magnetic component is invented. It is capable to make no air gap between the core of magnetic component and magnetic shielding material, avoid gap loss, reduce equipments or molds wear and enhance the magnetic paths and permeability.

The hot-forming magnetic component is composed of core, assembled coil, and magnetic glue.

The primary objectives of the present invention are:
1. With the technology and material of the Hot-forming Fabrication Method and Product of Magnetic Component of R.O.C. patent application, the core and magnetic shielding material can bond tightly so that the gap loss is avoided.
2. Because the invention is covered completely by the magnetic shielding material, the diverging magnetic field lines are contained and EMI is reduced efficiently.
3. The powder from conventional integrated magnetic component will damage the coil jacket during the high pressure forming process. However, upper and lower casings are used in a hot-forming magnetic component so that the damage of coil jacket can be prevented.
4. The rabbet problem is often existed in the similar products which have the upper and lower casings. But the invention has a special rabbet design to improve the rabbet shifting problems.
5. Because a drum core has an open side and coil design problems, the glue cannot be filled with the inside of drum core. Therefore, the cores and coils cannot be fixed, which caused the EMI noise indirectly. However, the invention, covered completely by the upper and lower casings is a hermetically sealed and empty inside which is left holes to fill it up with glue, can fix the cores and coils to solve the EMI noise problems.
6. The special glue with magnetic powder used in this invention can fill up the gaps of the component, and become the magnetic line paths to enhance the permeability.
7. The coils of a conventional integrated magnetic component are covered with magnetic powder. But the casings of this invention make the filling volume smaller than the former, which can lower the pressure during the forming process, reduce equipments or molds wear and save the time of forming process obviously.

### BRIEF DESCRIPTION OF THE DRAWINGS

FIG. 1 is a cross sectional view of finished product according to the present invention.

FIG. 2 is a cross sectional view of finished product, which is added the magnetic field lines, according to the present invention.

FIG. 3 is a cross sectional view of another type of finished product according to the present invention.

FIG. 4 is a cross sectional view of another type of finished product, which is added the magnetic field lines, according to the present invention.

FIG. 5 is a top view of the hot-forming fabrication of magnetic shielding casing and core according to the present invention.

FIG. 6 is a cross sectional view of the hot-forming fabrication of magnetic shielding casing and core according to the present invention.

FIG. 7 is a top view of the insulating base according to the present invention.

FIG. 8 is a cross sectional view of each different types of the combination of magnetic shielding casing and core according to the present invention.

FIG. 9 is a cross sectional view of each different types of the combination of magnetic shielding casings and core according to the present invention.

FIG. 10 is a cross sectional view of combinations of each different-shaped core and magnetic shielding casing according to the present invention.

FIG. 11 is a cross sectional view of a conventional open columnar magnetic component.

FIG. 12 is a cross sectional view of a drum core.

### DETAILED DESCRIPTION OF THE INVENTION

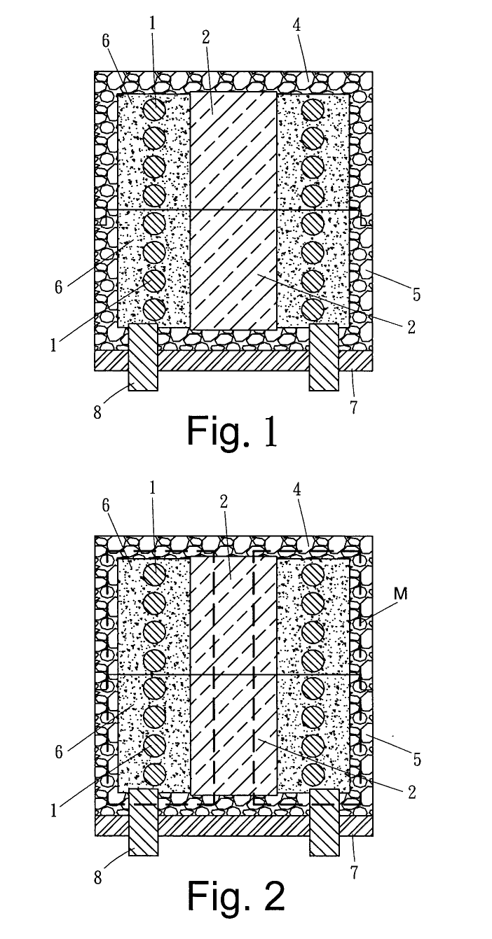

Referring to FIG. 1 for a cross sectional view of a hot-forming magnetic component according to the present invention, it includes a current-carrying coil 1, a core 2, a magnetic shielding upper casing 4, a magnetic shielding lower casing 5, magnetic glue 6, a insulating base 7 and the electric-conducting elements 8.

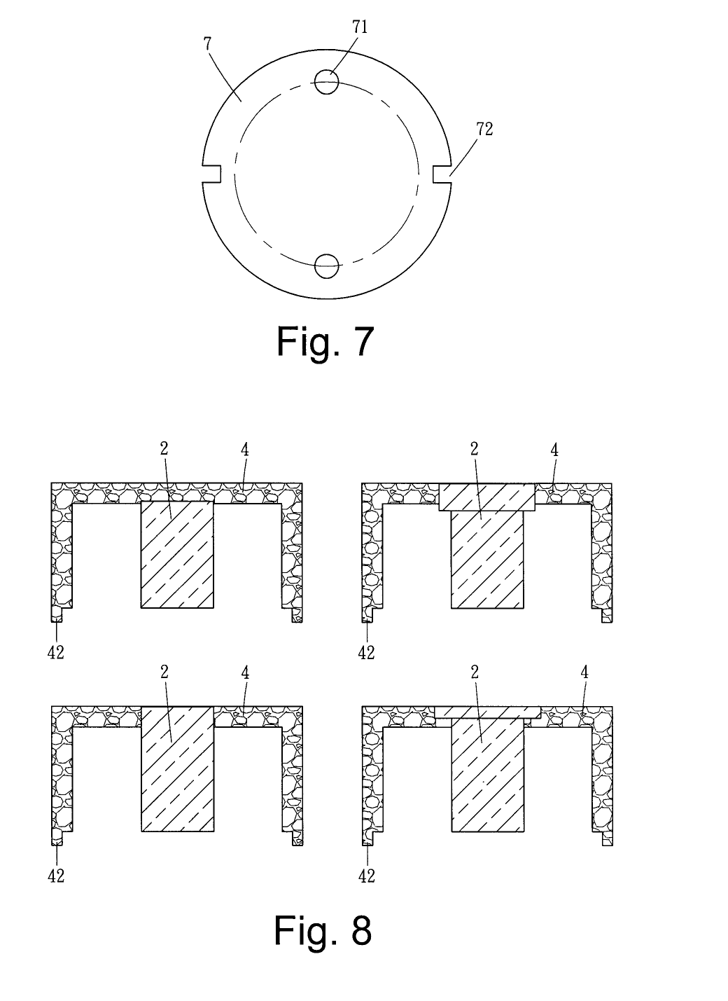

In FIGS. 1 and 7, one side of the core 2 and the magnetic shielding casings 4 and 5 are bonded together with hot-forming fabrication method. The casings 4 and 5 are open-containered lids 41 and 51, and the edge of lower casing 5 has a pair of symmetrical holes 54. The insulating base 7 is made of insulating materials such as Bakelite or Nylon, and it has symmetrical holes 71 and 72 which fits the holes 54 in the lower casing 5.

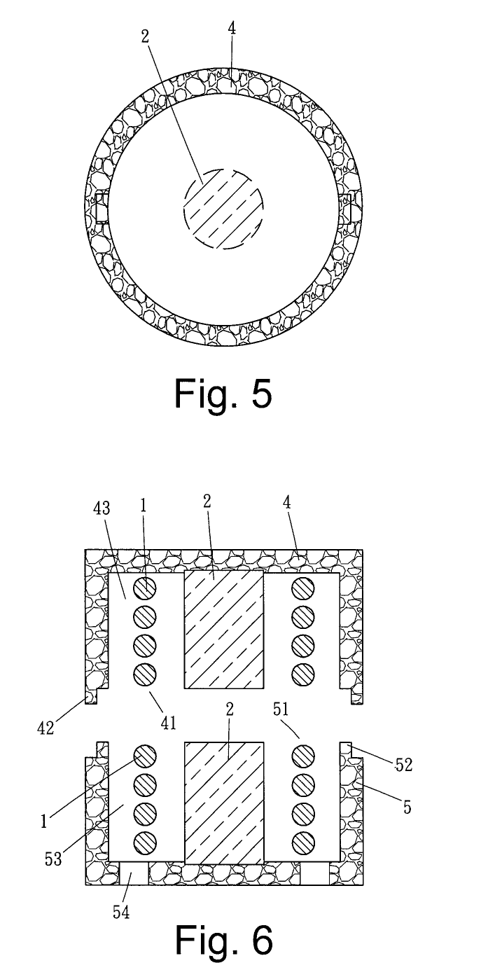

As shown in FIGS. 5 and 6, the core 2 is encapsulated in the containers 41 and 51 of casings 4 and 5. Then it is integrated into the casing 4 and 5. And inside the integrated container is a loop-shaped empty space 43 and 53.

There are symmetrical rabbets at the edges of casings 4 and 5, they help the two casings 4 and 5 close tightly. And the core 2 is the major source of the induction magnetic field.

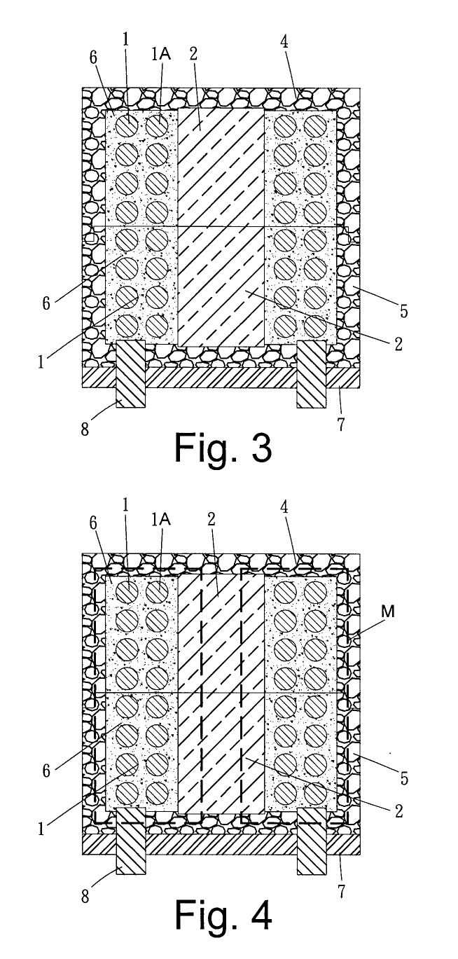

As shown in FIGS. 3 and 4, more than one current-carrying coil 1 and 1A which surface is insulating are placed in the aforesaid loop-shaped empty space 43 and 53. According to the design parameters, such as the coil inside diameter, the number of coil layer, and the turn number of coil, the current-carrying coil 1 which is wrapped single or several times by coils can help the current pass and make the external magnetic field.

The magnetic glue 6 is filled with the gaps between the loop-shaped empty space 43 and 53 and the current-carrying coil 1, and the glue is heated between 60° C. and 150° C. for 30 minutes to 3 hours to become solidification. So the glue can fill up the gaps between the coil 1 and the casings, fix the coils, solve the EMI noise problems, and provide magnetic path.

The magnetic glue 6 is made of hot-insulating glue and mixing magnetic powder. The hot-insulating glue includes epoxy, silicon or other glue which can be heat-proof over 100° C. And the mixing magnetic powder includes Höganäs SC200, SC100.26 and Beipiao Shenglong BF200.27, BF100.27, or the iron powder, alloy iron powder Fe, Al, Si, Cr, Ni, Co or other mixing powder which has similar magnetic permeability such as Sendust, Amorphous, MPP, and Hi-Flux.

The insulating base 7 is fixed outside the lower casing 5, and the side of lower casing 5, near the current-carrying coil 1, has a symmetrical conductive terminal 8 through the edge of casing 5 and the symmetrical holes 54 and 72 of insulating base 7, and the conductive terminal 8 is extended outward and fixed. The insulating base 7 can isolate the component from the board and fix the conductive terminal 8.

With the hot-forming fabrication method, the magnetic shielding upper casing 4, containing current-carrying coil 1, core 2 and magnetic glue 6, is bonded to the magnetic shielding lower casing 5, containing current-carrying coil 1, core 2, magnetic glue 6, insulating base 7, and conductive terminal 8, to create the hot-forming magnetic component.

In FIGS. 2 and 4, according to the Ampere's law, an external magnetic field is generated when the current passes through the current-carrying coil 1, and an induced magnetic field is generated by the core 2 which is induced by the external magnetic field. The whole component is covered completely by the magnetic shielding casings 4 and 5, therefore, the magnetic field line M as shown by the thick-hatched areas in FIGS. 2 and 4 will form an enclosed magnetic path through core 2 and the magnetic shielding materials. And this special design of the component has the following advantages:

a. With the hot-forming encapsulation, there is no air gap between the core and the magnetic shielding materials. Therefore, as the magnetic field lines go through the interface of core and magnetic shielding materials, the gap loss can be reduced greatly.

b. Because the whole component is covered completely by the magnetic shielding materials, the magnetic field lines can form an enclosed magnetic path through core and the magnetic shielding materials, which can lower the diverging magnetic field lines substantially.

c. The magnetic glue is filled with the gaps between the coil and the casings, so it can fix the coils to avoid the EMI noise problems, provide magnetic path, and enhance the permeability of the component. According to the experiment data, the permeability can be enhanced by 5% to 20%.

As shown in FIG. 8, the component, including casings 4, 5 and core 2, can be projected from the casings or not. And it can be columnar or T-shaped which can increase the contact surface area.

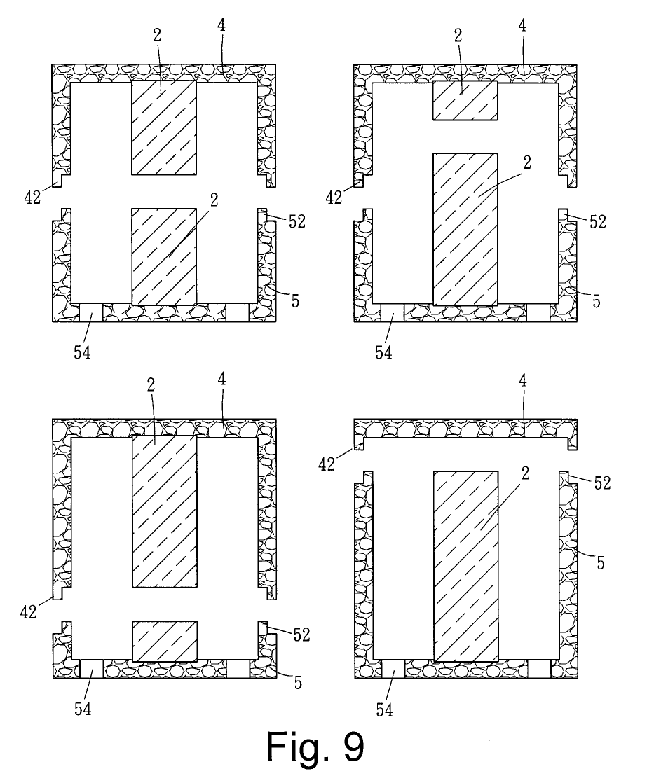

In FIG. 9, the proportion of heights of casing 4, 5 and core 2 can be implemented in a symmetrical way or not.

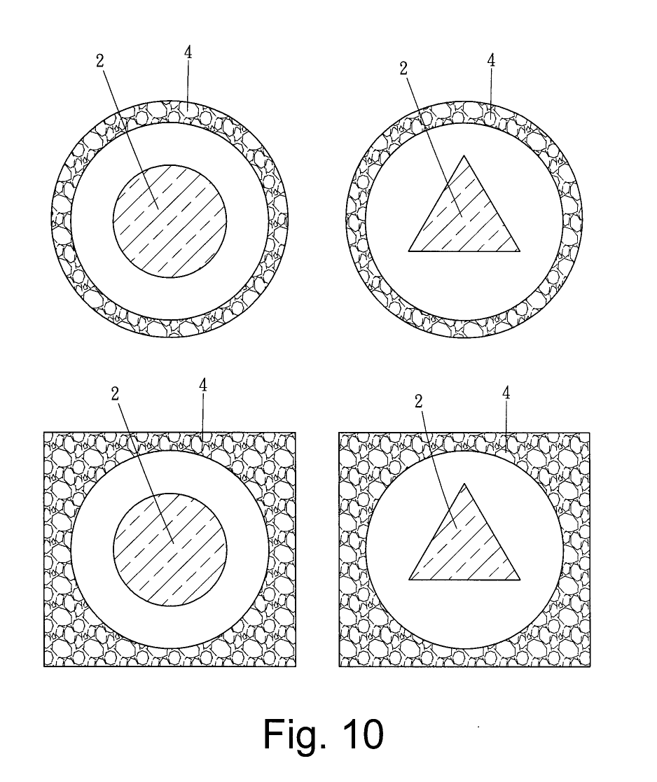

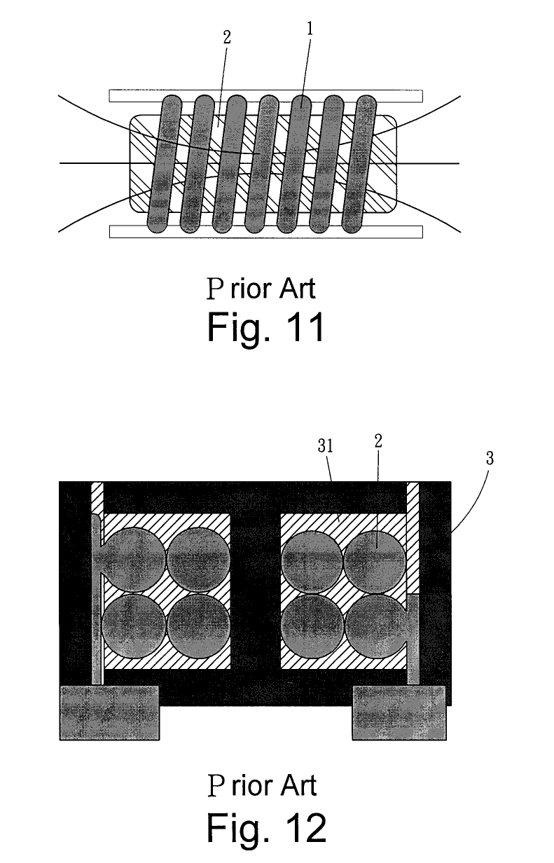

In FIG. 10, the shape of core 2 in the circular magnetic shielding casings 4 and 5 can be geometric form such as concentric circles, rectangular, or polygonal. And the shape of casings 4 and 5 outside the core 2 can be geometric form such as rectangular or polygonal as well.

According to the aforesaid, the hot-forming magnetic component can make no air gap between the core of magnetic component and magnetic shielding material, avoid gap loss, reduce equipments or molds wear, and enhance the magnetic paths and permeability.

What is claimed is:

1. A hot-forming magnetic component, comprising:
a magnetic shielding upper casing containing a current-carrying coil, a core and magnetic glue; and
a magnetic shielding lower casing containing a current-carrying coil, a core, magnetic glue, insulating base, and conductive terminal,
are boned together with the hot-forming fabrication method.

2. The hot-forming magnetic component of claim 1, wherein the core, encapsulated in the containers of two magnetic shielding casings, is integrated into the casings. And the integrated container inside is a loop-shaped empty space.

3. The hot-forming magnetic component of claim 2, wherein the loop-shaped empty space comprising more than one current-carrying coil which surface is insulating are placed. According to the design parameters, such as the coil diameter, the number of coil layer, and the turn number of coil, the current-carrying coil which is wound single or several times by coils can help the current pass and make the external magnetic field.

4. The hot-forming magnetic component of claim 1, wherein the implementing process of magnetic glue comprises steps of:
being filled with the gaps between the loop-shaped empty space and the current-carrying coil; and
being heated between 60° C. and 150° C. for 30 minutes to 3 hours to become solidification;
therefore, the glue can fill up the gaps between the coil and the casings, fix the coils, solve the EMI noise problems, and provide magnetic path.

5. The hot-forming magnetic component of claim 1, wherein the magnetic shielding upper and lower casings comprise symmetrical rabbets at the edges, which help the two casings close tightly.

6. The hot-forming magnetic component of claim 1, wherein the insulating base outside the magnetic shielding lower casing comprises insulating materials such as Bakelite or nylon.

7. The hot-forming magnetic component of claim 1, wherein the magnetic shielding lower casing and the insulating base comprise:
a symmetrical conductive terminal through the edge of casing, which is extended outward and fixed; and
two symmetrical holes.

8. The hot-forming magnetic component of claim 1, wherein the magnetic powder comprises an iron powder or an iron alloy powder Fe, Al, Si, Cr, Ni, Co selected from the group consisting of Höganäs SC200, SC100.26 and Beipiao Shenglong BF200.27, BF100.27 or comprises a mixed powder with similar magnetic permeability selected from the group consisting of Sendust, Amorphous, MPP, and Hi-Flux.

9. The hot-forming magnetic component of claim 1, wherein comprising the magnetic shielding casings and core, can be projected from the casings or not. And it can be columnar or T-shaped which can increase the contact surface area.

10. The hot-forming magnetic component of claim 1, wherein the proportion of heights of magnetic shielding casings and core can be implemented in a symmetrical way or not.

11. The hot-forming magnetic component of claim 1, wherein comprises:
a core in the circular magnetic shielding casings, which shape can be geometric form such as concentric circles, rectangular, or polygonal; and
two magnetic shielding casings outside the core, which shape can be geometric form such as rectangular or polygonal.
